(19) United States
(12) Patent Application Publication
(10) Pub. No.: US 2018/0211338 A1
(43) Pub. Date: Jul. 26, 2018

(54) Payment processing system, apparatus and method in real estate transactions

(71) Applicant: ASHLEY COOK, DALLAS, TX (US)

(72) Inventor: ASHLEY COOK, DALLAS, TX (US)

(21) Appl. No.: 15/416,251

(22) Filed: Jan. 26, 2017

(51) Int. Cl. G06Q 50/16; G06Q 40/02

(52) U.S. Cl. CPC G06Q 50/16; G06Q 40/025

(57) ABSTRACT

A web-based system for the capture and processing of payments in a real estate purchase and sale transaction comprising one or more user devices where user devices comprise one or more in the group of mobile phone, laptop, tablet and desktop PC and where users comprise Buyer, Buyer Agent, Seller, Seller Agent and Title Company Representative, an Application Server in communication with the one or more user devices via a browser over the Internet, the Application Server comprising a processor and data storage, data storage comprising information inputs relating to title companies, users, third party service providers/disbursees involved in real estate transactions, attributes of real properties and velocity controls relating to payment amount limits authorized for disbursements post closing to the third party service providers/disbursees, the Application Server in communication with a Title Company Processing Software and a Payment Processing Server.

### CLAIM OF PRIORITY

This Continuation-in-Part Patent Application incorporates in full by reference and is a continuation of Non-Provisional patent application Ser. No. 14/703,907 entitled “Payment processing system, apparatus and method in real estate transactions” which claims priority to Provisional Patent Application 61/991,555 filed on May 11, 2014 with the same title and by the same inventor.

### TRADEMARKS

The marks Zoccam™, Z℠ and ZocTalk℠ are trademarks owned by Zoccam Technologies, Inc.

### TITLE

Payment processing system, apparatus and method in real estate transactions

### BACKGROUND OF THE INVENTION

Computer-implemented systems for managing and preparing documentation relating to real estate transactions are known. Examples include U.S. Pat. No. 8,898,087 to Salzmann, et al. entitled Method and System for managing and preparing documentation for real estate transactions, U.S. patent application Ser. No. 14/208,953 to Bernadine W. Drake, et al. entitled “System and method for transferring payments and documents with a web-based management system” and U.S. Pat. No. 8,831,962 to Tsapov entitled “Systems, Methods and Software for Handling Title insurance and Relationships.” Remote deposit capture (mobile banking) of physical checks by a user/payee in possession of physical checks, into the payee's bank account is known and was enabled by so-called Check 21 law that allows for electronic checks (comprising images of the front and back of the physical check) as substitute, legally sufficient checks. Typical real estate transactions involve payments to parties to the transaction, their agents as well as third parties and include earnest money, option money (optionally). Buyer's Cash Due at Closing (amount due communicated to Buyer and Buyer Agent via Title Company Representative), real property appraisal, real property inspection, Homeowners Association Resale Certificate, repair on real property made by Seller, commissions due to buyer agent, buyer broker, seller agent and seller broker. Known methods for handling the payments concomitant to real estate purchase and sale transactions and closing of such transactions, which include forwarding/handling of paper checks and e-mailing of wire instructions, are prone to human error, transaction fees, delay and even fraud. The known risks in handling of payments include inefficiencies in handling of paper checks and inefficiencies in communications among parties to the transaction, their brokers and the title company. Additionally there is the known risk of the threat of unlawful access to e-mails from title company representative to the Buyer and/or the Buyer Agent containing wiring instructions for wiring of cash amounts due at closing. Finally, disbursement (at closing, post-closing) of checks to various parties involved in real estate transactions is an inefficient process handled by the title company representative and itself has the risk of introducing fraud. Title Company Processing Software, used by Title Company representatives, Title Company Escrow Agents to prepare a Closing Statement and to manage the Escrow Account is known. The disclosed system and methods reduce risks inherent in known methods for handling of payments relating to real estate closing transactions while increasing, for Buyers and Sellers and their respective agents, the transparency in the status of progress toward closing of a real estate purchase and sale transaction. Applicant is not aware of prior art that is a fully integrated, secure, authorized third party intermediated, computer-implemented system for the capture and automated processing of all payments involved in real estate closings which directly engages and connects Buyers Sellers and their agents and promotes transparency (via automated e-mail notifications) in the closing process for users of the system.

### SUMMARY OF THE INVENTION

The disclosed invention will be understood by the features and functionalities it affords to back-end and front-end users of the disclosed web-based application as more fully described herein. The disclosed system provides for automation of electronic payment processing in real estate closing transactions and connectedness (via application-generated e-mail notifications relating to payments) of subscribing front-end users and pre-boarded, pre-approved back-end users typically involved in real estate purchase and sale transactions. Thus the disclosed system promotes efficiency, including cost efficiencies in the handling of payments relating to real estate sale transactions while also promoting greater real time transparency in the capture and processing of said payments. The disclosed system comprises an Application Server that is in communication with user devices (including PCs, tablet, smartphone) over the Internet and with a Title Company Processing System (also sometimes referred to herein as ‘Title Company Software’) via a system integration between the Application Server and the Title Company Processing System and including a Payment Processing Server or alternatively Third Party Payment Processing Service Provider. A non-limiting, representative layered system architecture for implementing the disclosed system comprises a Mobile layer, a WebAPI layer, a storage layer (such as Microsoft Azure cloud), and an API layer providing for integration of the Application Server with external systems, including a credit card processing service provider (for processing of application subscription fees payable by users), a check processor, mobile messaging service provider, e-mail server, Google Web API's mapping services and a Title Company Processing System. Title Company Processing Software refers to known software applications used by title companies and their representatives and escrow agents to ‘open an order,’ initiating a process for effecting a closing of a real estate purchase and sale transaction and then processing the order (including calculating Cash Due at Closing and generating a Closing Disclosure document) with the aid of the software. The integration between the Application Server and the Title Company Processing Software provides in part the functionality that the front-end user (typically a Buyer or Buyer Agent) is prompted per a UI to scan and upload the executed Real Estate Purchase and Sale Contract thus causing the capture of certain metadata in that Contract and the efficient, automatic opening of an Order in the Title Company Processing Software. This step helps to enhance efficiencies in handling of closings by Title Company Representatives and or Title Company Escrow Agents.

The subscribing front-end users (Buyer, Buyer Agent, Buyer Broker, Seller, Seller Agent (also known as Listing Agent), Seller Broker) set up secure user accounts to access features and functionalities of the disclosed application. The system assigns to each user a unique user identifier (per an embodiment of the disclosed invention Applicant calls it a ‘Z Code’). The application prompts the users to provide identifying, authenticating information such as first name, last name, e-mail address, mobile telephone number, (for agents and brokers) real estate license number and the state that is the licensing authority and driver license number. Users such as the Buyer Agent, Buyer Broker, Seller Agent and Seller Broker may also be prompted to provide their respective bank account identifying information (so that disbursements after closing and per a Closing Statement can be handled as payments per the Automated Clearing House (ACH) rules for electronic processing of payments. The back-end users of the disclosed application include the Title Company (and specified branches), Title Company Representative(s), Title Company Processing Software, Title Company Escrow Agent, Title Company Bank, Buyer's Lender (if financing is involved), Underwriter, Third Party Vendors/Service Providers (see below) and Sales Agent of Developer (when Seller in the relevant Real Estate Purchase and Sale Contract is a builder/developer). Back-end users are authenticated and “pre-boarded” during the integration step. In pre-boarding, the provider/host or other authorized administrator user of the disclosed system inputs identifying information of authorized back-end users of the disclosed system. Pre-boarding also includes inputting identifying information relating to Third Party Vendors involved in the real estate purchase and sale transaction and also inputting so-called velocity controls for disbursements to the Third Party Vendors in which maximum allowed disbursement amounts are specified for each such Third Party Vendor (disbursee) entity receiving a disbursement (payment) at closing/post-closing. The term Third Party Vendor is herein construed broadly and refers to service providers and taxing authorities involved in real estate sales transactions and includes but is not limited to law firms/legal representatives of the parties to the transaction, the title company, tax assessor entities, underwriters and Homeowner's Warranty insurance providers. It is noted that an approval process is required for a Third Party Vendor that has not been pre-boarded. Pre-boarding is required if the Third Party Vendor is to be paid at/post closing via the disbursements functionality of the disclosed application. In strict liability states underwriters handle escrow thus taking away from independent title companies. Thus, per the disclosed system, underwriters may be pre-boarded thus preserving a role for the independent title company representative.

In so-called ‘broker escrow states,’ the Broker Escrow Account (as opposed to the Title Company Escrow Account) is designated for receiving escrow payments per the disclosed system. When the real estate sale and purchase contract is executed in the broker escrow states, the disclosed system allows for independent title companies to be involved in the transaction as follows: (1) The independent Title Company Representative receives the Real Estate Sale and Purchase Contract that the Buyer or Buyer Agent uploads via the disclosed application and (2) Remote deposit capture of the Buyer's escrow payment is processed per the described method (see Applicant's Non-provisional Patent Application specification, incorporated in full by reference) and is deposited in the Broker Escrow Account and the Application Server automatically sends an e-mail confirmation of that payment to the independent Title Company Representative.

Practicing the disclosed method for handling of payments involved in a real estate purchase and sale transaction typically includes the following steps:
(1) A Buyer and a Seller, through their respective real estate agents, enter into a written Real Estate Purchase and Sale Contract by respectively signing the Reach Estate Purchase and Sale Contract.
(2) As described in the Non-Provisional Patent Application, via a user device of the Buyer or Buyer Agent, the Buyer or Buyer Agent initiates a remote deposit capture of a physical check for earnest money (and optionally option money) due under the relevant Real Estate Purchase and Sale Contract and the disclosed Application Server then causes the secure transmission of the remote payment (via an integrated Third Party Payment Processing Service Provider) to the Title Company Escrow Account (or Broker Escrow Account, as appropriate) for the Title Company (and title company branch) in the transaction as selected by the Buyer or Buyer Agent via a prompting UI. Per this step, the Buyer or Buyer Agent is also prompted input information relating to the real property. Seller identifying information and check amount.
(3) The Application Server assigns a unique user identifier, called the Z Code, for the Buyer and Seller, Buyer Agent, Seller Agent, Buyer Broker and Seller Broker in the relevant real estate transaction. A Buyer Agent, a subscribing front-end user of the disclosed Application, inputs certain information relating to a real estate transaction. including Buyer Name (first, last), Buyer e-mail, Buyer (mobile) telephone number and Buyer's Driver License Number.
(4) A party in possession of the executed Real Estate Purchase and Sale Contract, typically a Buyer or Buyer Agent scans each page of the contract and uploads the images to the Application Server. Computer-executable instructions on the Application Server then cause the transmittal of the Real Estate Purchase and Sale Contract to a pre-boarded Title Company and the Title Company Processing System and the capture of certain metadata from the Real Estate Purchase and Sale Contract. The captured metadata preferably include but are not limited to the names of the parties to the contract, namely the Buyer and the Seller, sales price, the address for the real property, the amount of the escrow payment, and indication whether or not the buyer seeks financing. Similarly, when the Seller in a Real Estate Purchase and Sale Transaction is a Developer, the Real Estate Sales Contract between the Buyer and the Developer is communicated to the Title Processing System and the relevant metadata are automatically captured.

If the Real Estate Purchase and Sale Contract involves financing (as evidenced by captured metadata relating to the financing term/clause in the Contract), then the Application Server prompts the Buyer to optionally opt into authorizing the Lender to send a copy of the Closing Disclosure (CD) to the Buyer's Agent. This is a useful automated notification feature of the disclosed system as it enables the Buyer Agent to actively follow progress of the financing process to ensure that closing can take place as planned and that the Buyer provides the Lender all of the required information as required per the CD under the newly promulgated rules of the Consumer Financial Protection Board. The opt in by the Buyer protects both the Buyer and the Buyer Agent and ensures protection of the Buyer's personal identifiable information found in the CD.

The Application Server comprises computer-executable instructions for prompting the Seller Agent, Seller Broker, and if applicable Buyer Agent or Buyer Broker, to upload a scanned copy of each page of the Commission Disbursement Agreement (CDA) and once uploaded, the Application Server at Step 182 automatically e-mails the CDA to the Title Company Representative for use by the Title Company Representative in preparation of the Closing Statement and Closing Documents.

Per Step 174, the Application Server further comprises computer-executable instructions comprising a prompting message to the Buyer to optionally opt in for converting the Buyer's physical check representing Buyer's Cash Due at Closing to a wire. If the Buyer opts in, then at Step 189 the Application Server performs the Convert Check to Wire functionality after the Buyer captures an image of the front and back of the check and uploads the image to the Application Server.

Per Step 176, the Seller scans paid receipt (if any) evidencing Seller has paid for and completed a repair as agreed per a provision in the Real Estate Purchase and Sale Contract. The Application Server captures metadata from the Proof of Repairs Receipt including the amount paid and the identity of the Third Party Vendor that performed the repair. The captured metadata are communicated to the Title Company Processing System. The Application Server sends an automated notification of Proof of Repairs to the Buyer, Buyer Agent, Seller Agent, Title Company Representative (Title Company Escrow Agent) and the Lender.

Per Step 183, on a date that is before the date of closing set as per the Real Estate Contract (or date of closing as modified and approved by the Parties to the transaction and the Title Company Escrow Agent), the Application Server sends an automated e-mail notification to the Buyer and the Buyer Agent of the Cash Due At Closing amount as reflected on a Closing Statement generated by the Title Company Representative via Title Company Processing Software.

For certain transactions, such as transactions involving sale of condominium units, there is a provision for transmittal of Homeowners' Association Resale Certificate which contains important, relevant information sought by the buyer. Typically, the Homeowners' Association assessed a fee to create the HOA Resale Certificate signaling approval of a change in ownership of a unit. Thus the Application Server prompts the Seller or Seller Agent to upload the Homeowners' Association Resale Certificate (if applicable in the transaction) and once uploaded, the Application Server automatically sends an e-mail notification to the Buyer, Buyer Agent, Seller, the Seller Agent and the Title Company Representative.

The Closing Payments Disbursement System

Per a preferred embodiment of the disclosed system, a Closing Payments Disbursement Module functionality (or alternatively Closing Disbursements Functionality) is included. Thus, if the Title Company has opted into a service called the Post-Closing Payments Disbursement System Functionality, at the time of closing, the Application Server causes the computer-implemented execution of disbursement of payments due to all disbursees, including the parties to the real estate purchase and sale transaction, and their agents, and other third party vendors (service providers). So the term ‘disbursees’ as used herein includes but is not limited to one or more of the Seller (that is if the Seller has opted into receiving funds via the disclosed Closing Payments Disbursement functionality of the Application Server), Seller Agent, Seller Broker, Buyer Agent, Buyer Broker, Title Company, legal representative(s), taxing authority/authorities) per the Closing Statement. The Closing Statement, prepared by the Title Company Representative or Title Company Escrow Agent via Title Company Processing Software, itemizes all of the amounts due to each disbursee and identifies each disbursee.

Payment options in real estate transactions include ACH or wire (ACH being less expensive than a wire). Laws bar the use of ACH payments to escrow accounts and so payments to escrow accounts are typically made by wire and not ACH. Per a known process for disbursements of checks at or post closing, title company representative (typically the Escrow Agent) creates physical checks due to each of the myriad parties, ensures the checks are signed and the checks are then mailed. Errors may be introduced at each step. The disclosed system comprises a more efficient and secure with the added benefit of converting the checks to wire. Additionally, the current, known processes for effecting disbursements of checks after a closing has the potential to introduce human error (incorrect amount, incorrect disburse, lack of authorized signor(s)), fraud (wrong amount, incorrect disbursee, lack of authorized signors) and/or delay in processing (generating, mailing) the checks. The disclosed Closing Payments Disbursement Module functionality addresses each of these concerns by automating the creation of the disbursement checks, reducing the amount of dormant money, and by incorporating controls such as the requirement for two signors and the verification of the amounts of the checks against pre-set so-called ‘velocity controls’ for limits on the amounts payable to each specified disbursee. An added advantage is that the disbursement checks generated via the Application Server are ACH. The Application Server generates (‘prints’) electronic checks for each disbursee and in amounts as specified per the Closing Statement. In creating the electronic checks, no less than two (2) electronic signatures are required to be affixed to the electronic checks. After the electronic signatures are applied, the checks are converted to ACH and this is lawful as the check creation occurs outside of the escrow account. The electronic checks are then automatically deposited processed as wire transfers or as ACH payments and the Application Server causes the sending of automated e-mail notifications confirming the disbursements to all parties involved in the Closing. Controls per the Closing Payments Disbursements Functionality/System include but are not limited to the following: 1) Electronic signatures of two authorized individuals e-signing the checks are required and 2) pre-set velocity control verification step is applied for each check at the time that the electronic checks are generated. If an amount shown on the Closing Statement for any disbursee does not meet the pre-set velocity controls for that disbursee, the Application Server will not create the disbursement order, the Application Server will not generate that disbursement check and the Application Server will send an e-mail notification to one or more pre-authorized recipients designated to receive such notifications in that closing transaction flagging that a disbursement was not made. This step protects against human error and fraud that may occur in the disbursement process after closing.

### ZocTalk℠

Per a preferred embodiment of the disclosed application, there is included a mobile-enabled application that connects subscribing users that are licensed real estate agents and their brokers based on the content they post via the application via their user devices. So, for example, an agent may post content (including but not limited to freeform text, desired real property type (such as for example land for development, commercial lease, single-family home, condominium for sale, condominium or apartment for rent, etc.), photos, zip code, etc.) describing one or more attributes of a real property sought by his/her client, such as for example zip code(s). Based on the desired zip code(s) for that real property, the application pushes (sends) the content to application users that are licensed real estate agents and brokers in the zip code(s) and/or agents and brokers who ‘farm’ the specified zip code(s) and/or have (residential or commercial real estate) listings in the zip code(s). Today, agents and brokers utilize e-mail, face-to-face meetings and known social media platforms such as Facebook to communicate with their contacts (‘friends’) regarding real estate-related business. ZocTalk℠ offers a more efficient, secure alternative for agents and brokers to communicate real estate-related business with automatically targeted communications while preserving a professional image that is separate from the agents and brokers' non-business-related postings on social media.

### BRIEF DESCRIPTION OF THE DRAWINGS

FIG. 1 is a system architecture diagram per a preferred embodiment of the disclosed system for the capture and management of payments in real estate purchase and sale transactions;

FIG. 2 is an entity diagram showing the major entities that comprise the disclosed preferred embodiment for a system for the capture and management of payments in real estate purchase and sale transactions;

FIG. 3 is a block diagram showing inputs and outputs per the preferred embodiment for the disclosed system for the capture and management of payments in a real estate sales transactions

### DETAILED DESCRIPTION OF THE DRAWINGS

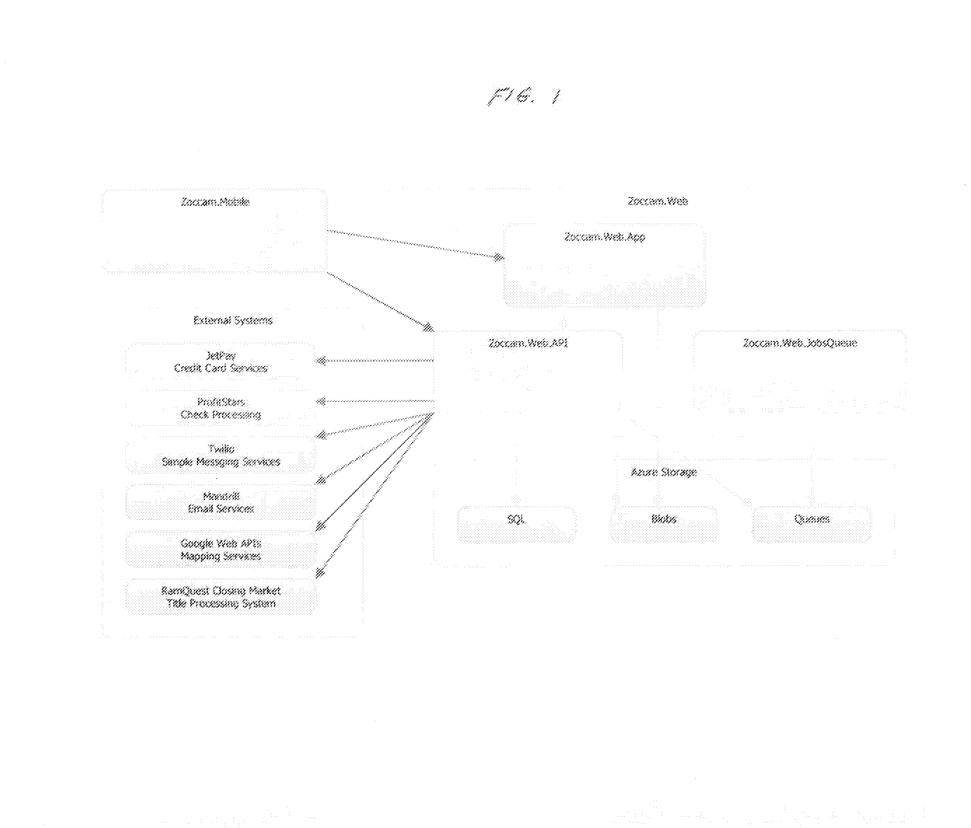

Per FIG. 1, showing the system architecture per a preferred embodiment, the disclosed web-based system comprises an Application Server that is in communication with user devices (including PCs, tablet, smartphone) over the Internet and with a Title Company Processing System via a system integration between the Application Server and the Title Company Processing System (also sometimes herein referred to as Title Company Software). A non-limiting, representative layered system architecture for implementing the disclosed system comprises Zoccam.Mobile layer, Zoccam.Web.API layer, Microsoft Azure storage layer, and an API layer providing for integration with external systems, including a credit card processing service provider, a check processor, mobile messaging service provider, e-mail server, Google Web API's mapping services and a Title Processing System.

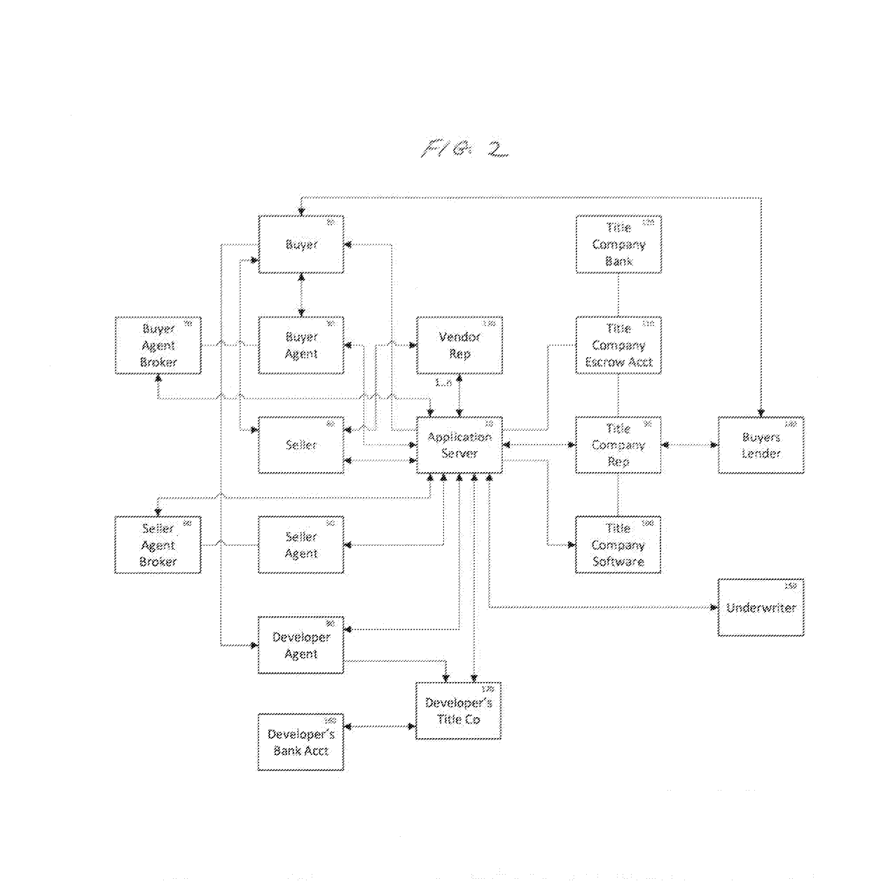

FIG. 2 is an entity relationship diagram showing the major entities and their interconnected ties per a preferred embodiment for the disclosed web-based system for the capture and management of payments in real estate transactions. The entities are two types, namely subscribing (human) users that access selected features and functionalities of the web application(s) comprising the Application Server 10 and ‘virtual’ account-type entities that are in communication with the Application Server via system integrations (some integrations, such as the integration with a third party check processing service, are not shown in this entity diagram) as part of the features and functionalities provided by the web application(s) of the Application Server. Thus shown is Application Server 10 in communication with user devices (not shown) of users over the Internet (not shown) where front-end users are Buyer 20, Buyer Agent 30, Buyer Agent Broker 70, Seller 40, Seller Agent 50, Seller Agent Broker 60, Developer Agent (when seller is a builder/developer) and back-end users are Title Company Representative 90. The Title Company Representative is in communication with or an authorized user of Title Company Software 100, Buyer's Lender 140, Title Escrow Account 110 and Underwriter 150 (if applicable). Shown is Developer's Title Company 170 (applicable when the seller is a developer/builder) in communication with the Application Sever 10 via an API not shown. Shown is the integration between the Application Server 10 and Title Company Software 100. Shown is Title Company Escrow Account 110 in communication with Title Company Bank 120. Shown are pre-boarded Vendor Representative 130 entities in communication with the Application Server 10. As explained above, the Vendor Rep 130 entities include any of a myriad of parties (Buyer Agent, Seller Agent, Seller Broker, Buyer Broker, taxing authority/authorities, service providers (e.g., attorney), etc.) who receive automated deposits of amounts as per amounts itemized per the Closing Statement generated by Title Company Representative 90 via Title Company Software and as per the closing disbursements functionality of the Application Server. Not shown in this diagram, but shown in drawings incorporated in full per the referenced provisional and non-provisional patent applications, is a Seller Bank entity that is in communication with the Third Party Payment Processing Server (also not shown) when Buyer sends option check payment to the Seller.

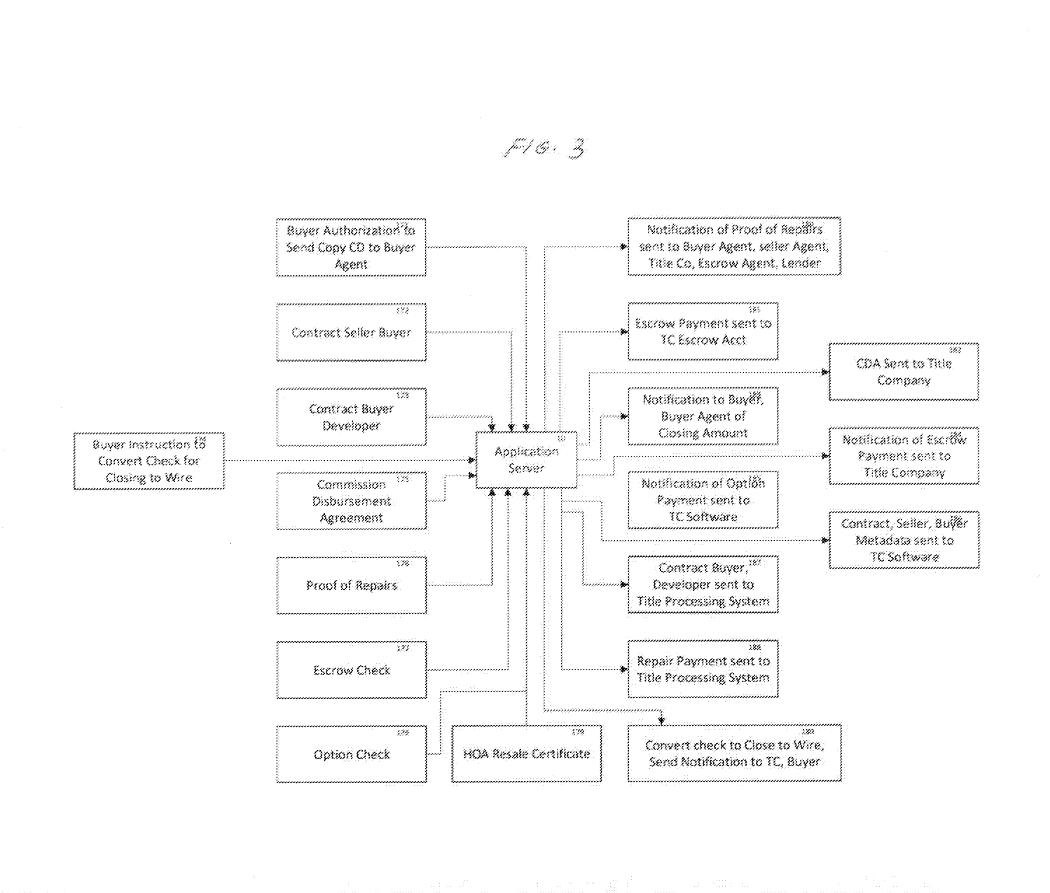

FIG. 3 is a block diagram showing input functionalities and output functionalities per the preferred embodiment for the disclosed system for the web-based capture and management of payments in a real estate sales transactions. Thus, shown are (user-initiated) input functionalities and corresponding application output functionalities as follows:
(1) Buyer Authorization to Send Copy of Closing Disclosure to Buyer Agent 171, where financing is involved in the transaction, whereby a Buyer using a Buyer device is prompted via a UI of the device to opt into authorizing the Lender and the Title Company Representative or Escrow Agent to send a copy of the Lender-prepared Closing Disclosure to the Buyer's Agent and where the opt in notification is sent to the Title Company Representative and/or Title Company Escrow Agent;
(2) Executed Real Estate Purchase and Sale Contract involving a Buyer and a Seller 172 whereby a Buyer or Buyer Agent using a Buyer or Buyer Agent device is prompted via an application UI to scan all pages of and upload the executed Real Estate Purchase and Sale Contract and the application, at Step 186, causes the sending of the capture of the document's metadata and ‘opening’ of an ‘Order’ via the integration between the Application Server and the Title Company Processing Software;
(3) Executed Real Estate Purchase and Sale Contract involving a Buyer and a Seller where the Seller is a Developer 173;
(4) Buyer Opt In/Instruction for Converting Physical Check for Buyer Cash Due at Closing to a Wire 174 whereby a Buyer using a Buyer device is prompted via a UI of the application to scan and upload a physical check representing payment of Buyer Cash Due at Closing and, as done at Step 189, have the application convert the captured check image to a wire payment and send notifications of said wire payment to the Buyer and the Title Company Representative or Title Company Escrow Agent;
(5) Commission Disbursement Agreement 175, where, typically, a Seller or Seller Agent or Seller Broker is prompted by an application UI to scan and upload a Commission Disbursement Agreement and the Application Server causes the sending, at Step 182, of the document, including captured metadata to the Title Company Representative;
(6) Proof of Repairs 176 whereby a Seller, using a Seller device, is prompted via an application UI to capture an image of a paid receipt evidencing Seller's payment for a required repair to the real property in the transaction, the repair performed by a pre-boarded, approved Third Party Vendor and whereupon, at Step 180, the Application Server transmits the Proof of Repairs document to the Title Company Representative or Escrow Agent the Buyer, Buyer Agent, Seller, Seller Agent and the Lender (if the transaction involves financing
(7) Escrow Check 177, whereby a Buyer or Buyer Agent via his/her device effects remote deposit capture (as described in Non-Provisional patent application Ser. No. 14/703,907 incorporated in full by reference) of a physical escrow check and the Application Server, via integration with a Third Party Payment Processor, causes the deposit of the escrow payment in the Buyer or Buyer Agent selected Title Company Escrow Account and, at Step 181, the Application Server also causes the sending of e-mail notifications of the deposit to the Buyer, Buyer Agent, Seller, Seller Agent and Title Company Representative and/or Title Company Escrow Agent;
(8) Option Check 178 whereby a Buyer or Buyer Agent via his/her device effects remote deposit capture (as described in Non-Provisional patent application Ser. No. 14/703,907 incorporated in full by reference) of a physical option check and the Application Server, via integration with a Third Party Payment Processor, causes the deposit of the option payment in a bank of the Seller and where, per Step 185, the Application Server causes the sending of e-mail notifications of the payment to at least the Seller, Seller Agent and the Title Company Representative,
(9) HOA Resale Certificate 179 is a document optionally included in the disclosed system. If applicable, via a UI of the disclosed application, a Seller or Seller Agent is prompted to scan and e-mail an HOA Resale Certificate, a special kind of disclosure document which may be necessary in order to properly effect a closing of a purchase and sale transaction involving a condominium or other real property involving a Homeowners' Association (HOA).

Thus, disclosed is a web-based system for the capture and processing of payments relating to a real estate purchase and sale transaction comprising

one or more user devices where user devices comprise one or more in the group of mobile phone, laptop, tablet and desktop PC and where users comprise Buyer, Buyer Agent, Seller, Seller Agent and Title Company Representative,
an Application Server in communication with the one or more user devices via a browser over the Internet, the user devices comprising a visual user interface,
the Application Server comprising a processor and data storage, data storage comprising information inputs relating to title companies, users, third party service providers/disbursees involved in real estate transactions, attributes of real properties and velocity controls relating to payment amount limits authorized for disbursements post closing to the third party service providers/disbursees,
the Application Server in communication with a Title Company Processing Software and a Payment Processing Server,
the Title Company Processing Software receiving inputs from authorized users of the Title Company Processing Software and the applications controlled by the Application Server and Selectively causing a capture of metadata thereof, the inputs comprising one or more of executed Real Estate Purchase and Sale Contract, Commission Disbursement Agreement, HOA Resale Certificate and Seller Proof of Repairs, the Application Server causing the automated sending of notification e-mails to the users confirming the receipt of such one or more inputs and
the Application Server causing the initiation of automated electronic deposit into authorized payee accounts of an Escrow Check and optionally an Option Check; images of a front face and back face of each said physical check captured by a Buyer or Buyer Agent using a Buyer device or Buyer Agent Device via prompts per an escrow check and option check remote deposit capture functionality of the application, the Application Server sending automatic e-mail notifications to said users confirming successful deposits upon receiving confirmation from the Payment Processing Server.

The above-disclosed system may further comprise a Closing Disbursements Functionality application whereby said application causes the creation of an electronic check for each disbursee identified per a Closing Statement generated via Title Company Processing Software in a check amount specified for that disbursee, automatically performs a velocity control verification of the amount on each electronic check against a pre-set velocity limit for the relevant disbursee, prompts the affixing of at least two e-signatures on each electronic check, and converts the electronic checks to ACH for electronic payment processing providing that the velocity control is satisfied and two authorized e-signatures are applied to the check.

Thus, per another feature of the above-disclosed system the Application Server receives from a Buyer device or Buyer Agent device an uploaded image of a front and back face of a physical check representing a Buyer's check for Buyer Cash Due at Closing and an instruction authorizing the conversion of said check to a wire payment, whereupon upon receiving said instruction, the Application Server causes the conversion of the uploaded images to an electronic check wire payment and the electronic deposit of funds into a Buyer or Buyer Agent-selected Title Company Escrow Account authorized in the real estate purchase and sale transaction, the Application Server sending e-mail notifications of said deposit to one or more in the group of the Buyer, Buyer Agent, Buyer Broker, Seller, Seller Agent, Seller Broker and Title Company Representative.

Per another feature of the disclosed system the Application Server receives from a Seller device an instruction whereby the Seller authorizes a disbursement of Seller Funds One at Closing, if applicable, via a Closing Disbursements Functionality of the Application Server whereby one or more electronic checks payable to one or more disbursees at closing are created in amounts per a Closing Statement, the amount on each check compared with a pre-set velocity control for the disbursee before being e-printed, the e-printed electronic checks e-signed by at least two authorized signors before being processed as a wire payment or via ACH.

Per the disclosed system the Payment Processing Server (which may or may not be a third party payment processing service provider) receives electronic checks created by the Application Server via a Closing Disbursements Functionality for disbursees per a Closing Statement generated via the Title Company Processing Software, causes electronic deposits of said electronic checks via ACH or wire into disburses payee accounts, sends confirmation of said deposits to the Application Server, the disbursees and disbursee bank accounts being pre-boarded and comprising one or more in the group of Seller, Seller Agent, Seller Broker, Buyer Agent, Buyer Broker, Lender and third party service provider in the relevant real estate sale and purchase transaction.

It is understood that the user devices per the disclosed system may be mobile phones.

Per another feature of the disclosed system the Application Server comprises a functionality providing a Buyer to optionally opt into allowing a Lender to transmit a copy of a Closing Disclosure to the Buyer's Agent, and whereby, if the Buyer opts in the Application Server sends a notification of said opt in to at least the Buyer's Agent and a Title Company Representative in the relevant purchase and sale transaction.

Per another feature of the disclosed system the Application Server comprises an application providing for a prompting one or more users from the group of Buyer, Buyer Agent, Seller Agent to input a query comprising attributes of a real estate sought by a user or client of the user as appropriate, the attributes comprising one or more zip codes, and wherein upon the input of said attributes, the Application Server sends said query to user devices of Seller Agents users who have real estate listings in the one or more zip codes.

It is understood that the Seller per the disclosed system may optionally be a Developer and in that instance the Title Company Software is a designated title company of the Developer.

The following method may be practiced using the above-disclosed system: In a web-based system for management and capture of payments in a closing of a real estate sale and purchase transaction, a computer-implemented method for making disbursements after a closing in a real estate purchase and sale transaction, the method comprising computer-executable instructions on a non-transitory medium causing the execution of the following steps:

Generating one or more electronic checks for each disbursee in a check amount specified for the check as per a Closing Statement, the Closing Statement generated by Title Company Processing Software and comprising identifying information for one or more disbursees.
Comparing the check amount with a pre-authorized velocity limit for each disbursee,
Prompting for an e-signing of each the one or more electronic checks by at least two pre-authorized signors,
Causing an e-printing of the one or more electronic checks if the velocity limit requirement is met for the check and if the check was e-signed by two pre-authorized e-signors and
Causing a processing of the e-printed electronic checks as wire payments or ACH.

I claim:

1. A web-based system for the capture and processing of payments relating to a real estate purchase and sale transaction comprising
one or more user devices where user devices comprise one or more in the group of mobile phone, laptop, tablet and desktop PC and where users comprise Buyer, Buyer Agent, Seller, Seller Agent and Title Company Representative,
an Application Server in communication with the one or more user devices via a browser over the Internet, the user devices comprising a visual user interface,
the Application Server comprising a processor and data storage, data storage comprising information inputs relating to title companies, users, third party service providers/disbursees involved in real estate transactions, attributes of real properties and velocity controls relating to payment amount limits authorized for disbursements post closing to the third party service providers/disbursees,
the Application Server in communication with a Title Company Processing Software and a Payment Processing Server,
the Title Company Processing Software receiving inputs from authorized users of the Title Company Processing Software and the applications controlled by the Application Server and selectively causing a capture of metadata thereof, the inputs comprising one or more of executed Real Estate Purchase and Sale Contract, Commission Disbursement Agreement, HOA Resale Certificate and Seller Proof of Repairs, the Application Server causing the automated sending of notification e-mails to the users continuing the receipt of such one or more inputs and
the Application Server earning the initiation of automated electronic deposit into authorized payee accounts of an Escrow Check and optionally an Option Check, images of a front face and back face of each said physical check captured by a Buyer or Buyer Agent using a Buyer device or Buyer Agent Device via prompts per an escrow check and option check remote deposit capture functionality of the application, the Application Server sending automatic e-mail notifications to said users confirming successful deposits upon receiving confirmation from the Payment Processing Server

2. The system per claim 1 further comprising a Closing Disbursements Functionality application whereby said application causes the creation of an electronic check for each disbursee identified per a Closing Statement generated via Title Company Processing Software in a check amount specified for that disbursee, automatically performs a velocity control verification of the amount on each electronic check against a pre-set velocity limit for the relevant disbursee, prompts the affixing of at least two e-signatures on each electronic check, and converts the electronic checks to ACH for electronic payment processing providing that the velocity control is satisfied and two authorized e-signatures are applied to the check.

3. The system per claim 1 wherein the Application Server receives from a Buyer device or Buyer Agent device an uploaded image of a front and back face of a physical check representing a Buyer's check for Buyer Cash Due at Closing and an instruction authorizing the conversion of said check to a wire payment, whereupon upon receiving said instruction, the Application Server causes the conversion of the uploaded images to an electronic check wire payment and the electronic deposit of funds into a Buyer or Buyer Agent-selected Title Company Escrow Account authorized in the real estate purchase and sale transaction, the Application Server sending e-mail notifications of said deposit to one or more in the group of the Buyer, Buyer Agent, Buyer Broker, Seller, Seller Agent, Seller Broker and Title Company Representative.

4. The system per claim 1 wherein the Application Server receives from a Seller device an instruction whereby the Seller authorizes a disbursement of Seller Funds Due at Closing, if applicable, via a Closing Disbursements Functionality of the Application Server whereby one or more electronic checks payable to one or more disbursees at closing are created in amounts per a Closing Statement, the amount on each check compared with a pre-set velocity control for the disbursee before being e-printed, the e-printed electronic checks e-signed by at least two authorized signors before being processed as a wire payment or via ACH.

5. The system per claim 1 wherein the Payment Processing Server receives electronic checks created by the Application Server via a Closing Disbursements Functionality for disbursees per a Closing Statement generated via the Title Company Processing Software, causes electronic deposits of said electronic checks via ACH or wire into disbursee/payee accounts, sends confirmation of said deposits to the Application Server, the disbursees and disbursee bank accounts being pre-boarded and comprising one or more in the group of Seller, Seller Agent, Seller Broker, Buyer Agent, Buyer Broker, Lender and third party service provider in the relevant real estate sale and purchase transaction.

6. The system per claim 1 wherein the Application Server comprises a visual UI prompting a Buyer to optionally opt into allowing a Lender to transmit a copy of a Closing Disclosure to the Buyer's Agent, and whereby, if the Buyer opts in the Application Server sends a notification of said opt in to at least the Buyer's Agent and a Title Company Representative in the relevant purchase and sale transaction.

7. The system per claim 1 wherein the Application Server comprises an application comprising prompting one or more user from the group of Buyer, Buyer Agent, Seller Agent to input a query comprising attributes of a real estate sought by a user or client of the user as appropriate, the attributes comprising one or more zip codes, and wherein upon the input of said attributes, the Application Server sends said query to user devices of Seller Agents users who have real estate listings in the one or more zip codes.

8. The system per claim wherein the Seller is a Developer and Title Company Software is a designated title company of the Developer.

9. In a web-based system for management and capture of payments in a closing of a real estate sale and purchase transaction, a computer-implemented method for making disbursements after a closing in a real estate purchase and sale transaction, the method comprising computer-executable instructions on a non-transitory medium causing the execution of the following steps:
Generating one or more electronic checks for each disbursee in a check amount specified for the check as per a Closing Statement, the Closing Statement generated by Title Company Processing Software and comprising identifying information for one or more disbursees,
Comparing the check amount with a pre-authorized velocity limit for each disbursee,
Prompting for an e-signing of each the one or more electronic checks by at least two pre-authorized signors,
Causing an e-printing of the one or more electronic checks if the velocity limit requirement is met for the check and if the check was e-signed by two pre-authorized e-signors and
Causing a processing of the e-printed electronic checks as wire payments or ACH.
